(19) United States
(12) Patent Application Publication
(10) Pub. No.: US 2014/0247249 A1
(43) Pub. Date: Sep. 4, 2014

(54) Touch Sensitive Display Devices

(71) Applicant: Light Blue Optics Ltd, Cambridge (GB)

(72) Inventors: Euan Christopher Smith, Cambridgeshire (GB); Jonathan Freeman, Cambridgeshire (GB)

(21) Appl. No.: 14/349,956

(22) PCT Filed: Oct. 8, 2012
(86) PCT No.: PCT/GB2012/052486

§ 371 Date: Apr. 4, 2014

(30) Foreign Application Priority Data
Oct. 11, 2011 (GB) GB117542.9

(51) Int. Cl. G06F 3/042; G06F 3/041

(52) U.S. Cl. CPC G06F 3/0425; G06F 3/0418
USPC 345/175

(57) ABSTRACT

Some embodiments of the present invention provide touch sensitive image display devices including: an image projector to project a displayed image onto a surface; a touch sensor light source to project a plane of light above the displayed image; a camera to capture a touch sense image from light scattered from the plane of light by an approaching object; and a signal processor to process the touch sense image to identify a location of the object. The light path to the touch sensor camera includes a keystone-distortion compensating topical element, in particular a convex curved aspherical minor.

### CROSS REFERENCE TO RELATED APPLICATION

This application claims priority to PCT Application No. PCT/GB2012/052486 entitled “Touch Sensitive Display Devices” and filed Oct. 8, 2012, which itself claims priority to GB 1117542.9 filed Oct. 11, 2011. The entirety of each of the aforementioned applications is incorporated herein by reference for all purposes.

### FIELD OF THE INVENTION

This invention relates to touch sensitive image projection systems, and to related methods and corresponding processor control code. More particularly the invention relates to systems employing image projection techniques in combination with a touch sensing system which projects a plane of light adjacent the displayed image.

### BACKGROUND OF THE INVENTION

Background prior art relating to touch sensing systems employing a plane of light can be found in U.S. Pat. No. 6,281,878 (Montellese), and in various later patents of Lumio/VKB Inc, such as U.S. Pat. No. 7,305,368, as well as in similar patents held by Canesta Inc, for example U.S. Pat. No. 6,710,770. Broadly speaking these systems project a fan-shaped plane of infrared (IR) light just above a displayed image and use a camera to detect the light scattered from this plane by a finger or other object reaching through to approach or touch the displayed image.

Further background prior art can be found in: WO01/93006; U.S. Pat. No. 6,650,318; U.S. Pat. No. 7,305,368; U.S. Pat. No. 7,084,857; U.S. Pat. No. 7,268,692; U.S. Pat. No. 7,417,681; U.S. Pat. No. 7,242,388 (US2007/222760); US2007/019103; WO01/93006; WO01/93182; WO2008/038275; US2006/187199; U.S. Pat. No. 6,614,422; U.S. Pat. No. 6,710,770 (US2002021287); U.S. Pat. No. 7,593,593; U.S. Pat. No. 7,599,561; U.S. Pat. No. 7,519,223; U.S. Pat. No. 7,394,459; U.S. Pat. No. 6,611,921; U.S. D. 595,785; U.S. Pat. No. 6,690,357; U.S. Pat. No. 6,377,238; U.S. Pat. No. 5,767,842; WO2006/108443; WO2008/146098; U.S. Pat. No. 6,367,933 (WO00/21282); WO02/101443; U.S. Pat. No. 6,491,400; U.S. Pat. No. 7,379,619; US2004/0095315; U.S. Pat. No. 6,281,878; U.S. Pat. No. 6,031,519; GB2,343,023A; U.S. Pat. No. 4,384,201; DE 41 21 180A; and US2006/244720.

We have previously described techniques for improved touch sensitive holographic displays, in particular in our earlier patent applications: WO2010/073024; WO2010/073045; and WO2010/073047. The inventors have continued to develop and advance touch sensing techniques relating to these systems.

### BRIEF DESCRIPTION OF THE DRAWINGS

These and other aspects of the invention will now be further described, by way of example only, with reference to the accompanying figures in which:

FIGS. 1a and 1b show, respectively, a vertical cross section view through an example touch sensitive image display device suitable for implementing embodiments of the invention, and details of a plane of light-based touch sensing system for the device;

FIGS. 2a and 2b show, respectively, a holographic image projection system for use with the device of FIG. 1, and a functional block diagram of the device of FIG. 1;

FIGS. 3a to 3d show, respectively, an embodiment of a touch sensitive image display device according to an aspect of the invention, use of a crude peak locator to find finger centroids, and the resulting finger locations, and an illustration of alternative camera locations;

FIG. 4 shows, schematically, a distortion correcting optical scheme in an embodiment of a touch sensing display device according to the invention;

FIGS. 5a and 5b show the effect of the distortion correcting optics on the camera view; and

FIGS. 6a and 6b show, respectively, a schematic illustration of an embodiment of a touch sensing display device according to the invention, and functional block diagram of the device illustrating use by/sharing of the mirror with the projection optics.

### BRIEF SUMMARY OF THE INVENTION

Broadly speaking we will describe a camera based electronic device which detects interaction with, or in proximity to, a surface where the camera optical system includes a curved, aspherical minor.

In some embodiments of the present invention, the camera optical system includes other optical elements such as minors or lenses which, in conjunction with the minor, provides a largely distortion-free view of the said surface.

In some embodiments of the present invention, the electronic device also incorporates a light source to produce a sheet of light positioned parallel to the said surface.

In some embodiments of the present invention, multiple light sources and/or multiple light sheets are used.

In some embodiments of the present invention, the camera system is designed to detect light scattering off objects crossing the light sheet or sheets.

In some embodiments of the present invention the device is able to report positions and/or other geometrical information of objects crossing the said light sheet or sheets. Preferably such positions are reported as touches. Preferably the device is able to use information captured by the camera to interpret gestures made on or close to the said surface.

In some embodiments of the present invention the device is used with a projection system to provide an image on the surface. Then preferably both the camera system and the projector use the same minor to distortion correct both the projected image onto, and camera view of, the surface.

In some embodiments of the present invention the camera and projector use the same or overlapping areas of the mirror. Alternatively the camera and projector may use different areas of the mirror.

In embodiments the minor, optimized primarily for projection, produces some degree of distortion or blurring of the camera image and this distortion or blurring is compensated for in the camera image analysis.

According to further aspects of the invention there is provided a touch sensing system, the system comprising: a touch sensor light source to project a plane or fan of light above a surface; a camera having image capture optics configured to capture a touch sense image from a region including at least a portion of said plane of light, said touch sense image comprising light scattered from said plane of light by an object approaching said displayed image; and a signal processor coupled to said camera, to process a said touch sense image from said camera to identify a location of said object; wherein said image capture optics are configured to capture said touch sense image from an acute angle relative to said plane of light; and wherein said image capture optics are configured to compensate for distortion resulting from said acute angle image capture.

In embodiments the image capture optics have an optic axis directed at an acute angle to the plane of light. For example the angle between the center of the input of the image capture optics and the middle of the captured image (the angle to a line in the surface of the plane of light), is less than 90°. Thus the image capture optics may be configured to compensate for keystone distortion resulting from this acute angle image capture, preferably as well as for other types of distortion which arise from very wide angle image capture such as barrel distortion and other types of distortion. Use of very wide angle image capture is helpful because it allows the camera to be positioned relatively close to the touch surface, which is turn facilitates a compact system and collection of a larger proportion of the scattered light, hence increasing sensitivity without the need for large input optics. For example the optics may include a distortion compensating optical element such as a convex, more particularly an aspheric mirror surface. Thus the image capture optics may be configured to compensate for the trapezoidal distortion of a nominally rectangular input image field caused by capture from a surface at an angle which is not perpendicular to the axis of the input optics, as well as for other image distortions resulting from close-up, wide-angle viewing of the imaged region.

In embodiments the minor surface is arranged to map bundles of light rays (field rays) from points on a regular grid in the touch sense imaged region to a regular grid in a field of view of the camera. Consider, for example, a bundle of rays emanating from a point in the images region; these define a cone bounded by the input aperture of the camera (which in embodiments may be relatively small). Part-way towards the camera the cross-sectional area of this cone is relatively small. The mirror surface may be notionally subdivided into a grid of reflecting regions, each region having a surface which is approximately planar. The direction of specular reflection from each planar region is chosen to direct the bundle of (field) rays from the point on the image from which it originates to the desired point in the field of view of the camera, so that a regular grid of points in the imaged region maps substantially to a regular grid of points in the field of view of the camera. Thus the minor surface may be treated as a set of locally-flat regions, each configured to map a point on a regular grid in the touch sense image plane into a corresponding point on a regular grid in the camera field of view.

In practice, however, the local surface of each region of the minor is not exactly flat because a design procedure will usually involve an automatic optimization, allowing the shape of the mirror surface to vary to optimize one or more parameters, such as brightness/focus/distortion compensation, and the like. In general, however, the surface of the minor will approximate the shape of a conic section (excluding a circle), most often a parabola.

Although the minor surface may be locally substantially flat, or at least not strongly curved, in embodiments some small curvature may be applied to compensate for the variation in depth within the image field of points within the captured touch sense image. Thus the mirror surface may be arranged to provide (positive or negative) focusing power, varying over the minor surface, to compensate for variation in distances of points within the imaged region from an image plane of the camera due to the acute angle imaging. Thus, in effect, rays from a “far” point in the imaged region may be given less focusing power rays from a near point.

The skilled person will appreciate that although embodiments conveniently employ a minor as the distortion compensating optical element, other optical elements, or combinations of optical elements, may alternatively be employed, for example a lens and/or a static or dynamic diffractive optical element.

Preferred implementations of the touch sensing system are combined with an image projector to project a displayed image onto the surface. Then the touch sensor light source may be configured to project the plane of light above said displayed image, and the signal processor may be configured to identify a location of the object—which may be a finger—relative to the displayed image. In embodiments image projector is configured to project a displayed image onto said surface at a second acute angle (which may be the same as the first acute angle).

In embodiments the distortion compensating optical element is configured to provide more accurate distortion compensation for the image projector than for the camera. Then the signal processor coupled to the camera may be configured to compensate for any residual image distortion arising from arranging for the camera optics to better compensate the projector than the camera.

In embodiments the device may be supported on a stand or may have a housing with a base which rests on/against the display surface. The front of the device may comprise a black plastic infrared transmissive window. The sheet illumination optics and a scattered light (imaging) sensor to image the display area may be positioned between the image projection optics and the sheet illumination system to view the display area (at an acute angle). Using infrared light enables the remote touch sensing system to be concealed behind a black, IR transmissive window; also use of infrared light does not detract from the visual appearance of the displayed image.

In a related aspect the invention provides a method of implementing a touch sensing system, the system comprising: projecting a plane of light above a surface; capturing a touch sense image from a region including at least a portion of said plane of light using a camera, said touch sense image comprising light scattered from said plane of light by an object approaching said displayed image, wherein said capturing comprises capturing said touch sense image from an acute angle relative to said plane of light; compensating for distortion resulting from said acute angle image capture using image capture optics coupled to said camera; and processing a said distortion-compensated touch sense image from said camera to identify a location of said object.

### DETAILED DESCRIPTION

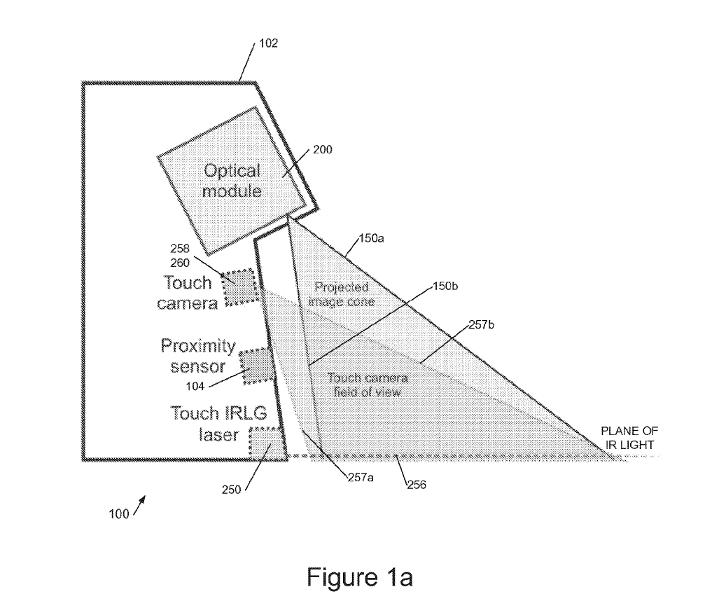

FIGS. 1a and 1b show an example touch sensitive holographic image projection device 100 comprising a holographic image projection module 200 and a touch sensing system 250, 258, 260 in a housing 102. A proximity sensor 104 may be employed to selectively power-up the device on detection of proximity of a user to the device.

A holographic image projector is merely described by way of example; the techniques we describe herein may be employed with any type of image projection system.

The holographic image projection module 200 is configured to project downwards and outwards onto a flat surface such as a tabletop. This entails projecting at an acute angle onto the display surface (the angle between a line joining the center of the output of the projection optics and the middle of the displayed image and a line in a plane of the displayed image is less than 90°). We sometimes refer to projection onto a horizontal surface, conveniently but not essentially non-orthogonally, as “table down projection”. A holographic image projector is particularly suited to this application because it can provide a wide throw angle, long depth of field, and substantial distortion correction without significant loss of brightness/efficiency. Boundaries of the light forming the displayed image 150 are indicated by lines 150a, b.

The touch sensing system 250, 258, 260 comprises an infrared laser illumination system (IR line generator) 250 configured to project a sheet of infrared light 256 just above, for example ˜1 mm above, the surface of the displayed image 150 (although in principle the displayed image could be distant from the touch sensing surface). The laser illumination system 250 may comprise an IR LED or laser 252, preferably collimated, then expanded in one direction by light sheet optics 254, which may comprise a negative or cylindrical lens. Optionally light sheet optics 254 may include a 45 degree mirror adjacent the base of the housing 102 to fold the optical path to facilitate locating the plane of light just above the displayed image.

A CMOS imaging sensor (touch camera) 260 is provided with an it-pass lens 258 captures light scattered by touching the displayed image 150, with an object such as a finger, through the sheet of infrared light 256. The boundaries of the CMOS imaging sensor field of view are indicated by lines 257, 257a,b. The touch camera 260 provides an output to touch detect signal processing circuitry as described further later.

### Example Holographic Image Projection System

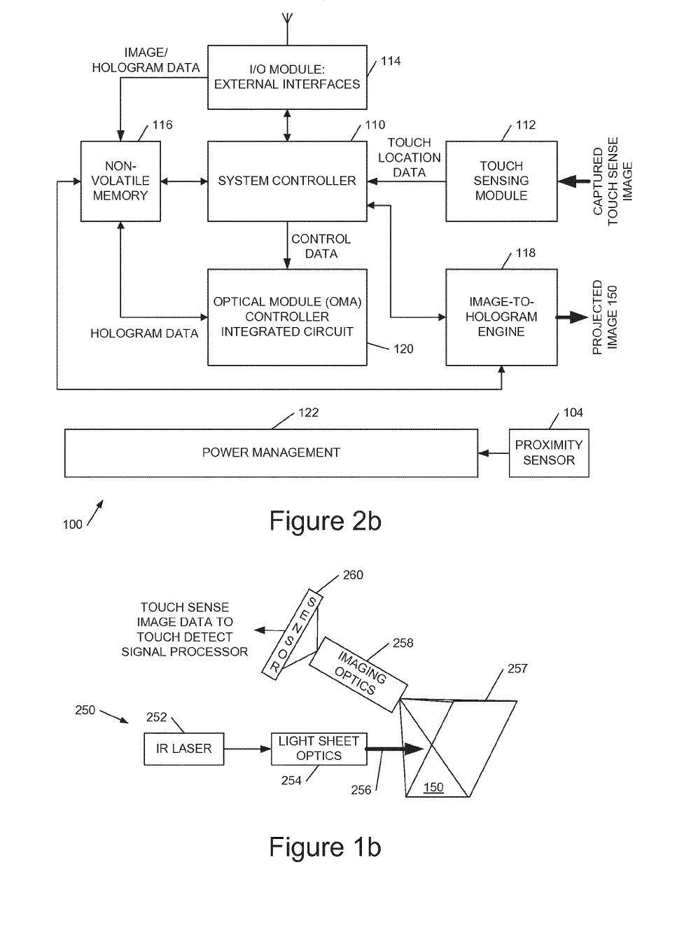

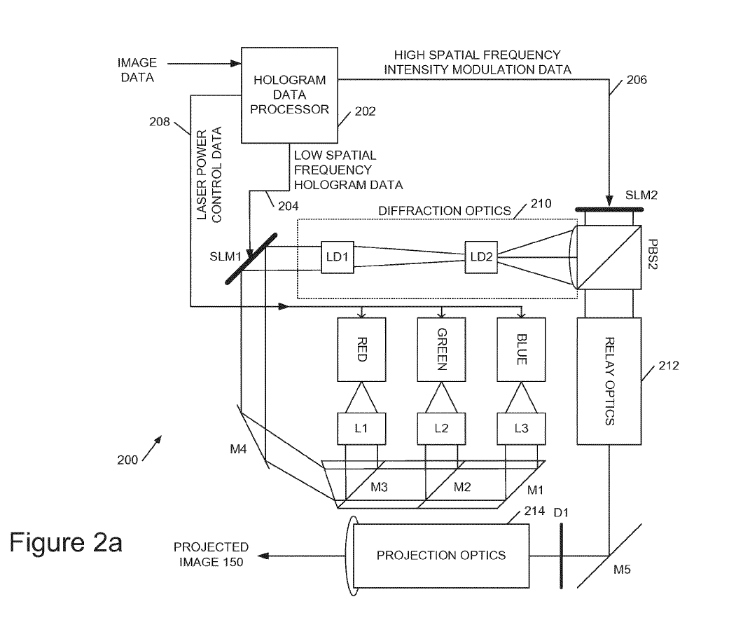

FIG. 2a shows an example holographic image projection system architecture 200 in which the SLM may advantageously be employed. The architecture of FIG. 2 uses dual SLM modulation—low resolution phase modulation and higher resolution amplitude (intensity) modulation. This can provide substantial improvements in image quality, power consumption and physical size. The primary gain of holographic projection over imaging is one of energy efficiency. Thus the low spatial frequencies of an image can be rendered holographically to maintain efficiency and the high-frequency components can be rendered with an intensity-modulating imaging panel, placed in a plane conjugate to the hologram SLM. Effectively, diffracted light from the hologram SLM device (SLM1) is used to illuminate the imaging SLM device (SLM2). Because the high-frequency components contain relatively little energy, the light blocked by the imaging SLM does not significantly decrease the efficiency of the system, unlike in a conventional imaging system. The hologram SLM is preferably be a fast multi-phase device, for example a pixellated MEMS-based piston actuator device.

In FIG. 2a:
SLM1 is a pixellated MEMS-based piston actuator SLM as described above, to display a hologram—for example a 160×160 pixel device with physically small lateral dimensions, e.g <5 mm or <1 mm.
L1, L2 and L3 are collimation lenses (optional, depending upon the laser output) for respective Red, Green and Blue lasers.
M1, M2 and M3 are dichroic mirrors a implemented as prism assembly.
M4 is a turning beam minor.
SLM2 is an imaging SLM and has a resolution at least equal to the target image resolution (e.g. 854×480); it may comprise a LCOS (liquid crystal on silicon) or DMD (Digital Micromirror Device) panel.
Diffraction optics 210 comprises lenses LD1 and LD2, forms an intermediate image plane on the surface of SLM2, and has effective focal length f such that fλ/Δ covers the active area of imaging SLM2. Thus optics 210 perform a spatial Fourier transform to form a far field illumination pattern in the Fourier plane, which illuminates SLM2.
PBS2 (Polarizing Beam Splitter 2) transmits incident light to SLM2, and reflects emergent light into the relay optics 212 (liquid crystal SLM2 rotates the polarization by 90 degrees). PBS2 preferably has a clear aperture at least as large as the active area of SLM2.
Relay optics 212 relay light to the diffuser D1.
M5 is a beam turning mirror.
D1 is a diffuser to reduce speckle.
Projection optics 214 project the object formed on D1 by the relay optics 212, and preferably provide a large throw angle, for example >90°, for angled projection down onto a table top (the design is simplified by the relatively low entendue from the diffuser).

The different colors are time-multiplexed and the sizes of the replayed images are scaled to match one another, for example by padding a target image for display with zeroes (the field size of the displayed image depends upon the pixel size of the SLM not on the number of pixels in the hologram).

A system controller and hologram data processor 202, implemented in software and/or dedicated hardware, inputs image data and provides low spatial frequency hologram data 204 to SLM1 and higher spatial frequency intensity modulation data 206 to SLM2. The controller also provides laser light intensity control data 208 to each of the three lasers. For details of an example hologram calculation procedure reference may be made to WO2010/007404 (hereby incorporated by reference).

### Control System

Referring now to FIG. 2b, this shows a block diagram of the device 100 of FIG. 1. A system controller 110 is coupled to a touch sensing module 112 from which it receives data defining one or more touched locations on the display area, either in rectangular or in distorted coordinates (in the latter case the system controller may perform keystone distortion compensation). The touch sensing module 112 in embodiments comprises a CMOS sensor driver and touch-detect processing circuitry.

The system controller 110 is also coupled to an input/output module 114 which provides a plurality of external interfaces, in particular for buttons, LEDs, optionally a USB and/or Bluetooth® interface, and a bi-directional wireless communication interface, for example using WiFi®. In embodiments the wireless interface may be employed to download data for display either in the form of images or in the form of hologram data. In an ordering/payment system this data may include price data for price updates, and the interface may provide a backhaul link for placing orders, handshaking to enable payment and the like. Non-volatile memory 116, for example Flash RAM is provided to store data for display, including hologram data, as well as distortion compensation data, and touch sensing control data (identifying regions and associated actions/links). Non-volatile memory 116 is coupled to the system controller and to the 110 module 114, as well as to an optional image-to-hologram engine 118 as previously described (also coupled to system controller 110), and to an optical module controller 120 for controlling the optics shown in FIG. 2a. (The image-to-hologram engine is optional as the device may receive hologram data for display from an external source). In embodiments the optical module controller 120 receives hologram data for display and drives the hologram display SLM, as well as controlling the laser output powers in order to compensate for brightness variations caused by varying coverage of the display area by the displayed image (for more details see, for example, our WO2008/075096). In embodiments the laser power(s) is(are) controlled dependent on the “coverage” of the image, with coverage defined as the sum of: the image pixel values, preferably raised to a power of gamma (where gamma is typically 2.2). The laser power is inversely dependent on (but not necessarily inversely proportional to) the coverage; in preferred embodiments a lookup table as employed to apply a programmable transfer function between coverage and laser power. The hologram data stored in the non-volatile memory, optionally received by interface 114, therefore in embodiments comprises data defining a power level for one or each of the lasers together with each hologram to be displayed; the hologram data may define a plurality of temporal holographic sub frames for a displayed image. Preferred embodiments of the device also include a power management system 122 to control battery charging, monitor power consumption, invoke a sleep mode and the like.

In operation the system controller controls loading of the image/hologram data into the non-volatile memory, where necessary conversion of image data to hologram data, and loading of the hologram data into the optical module and control of the laser intensities. The system controller also performs distortion compensation and controls which image to display when and how the device responds to different “key” presses and includes software to keep track of a state of the device. The controller is also configured to transition between states (images) on detection of touch events with coordinates in the correct range, a detected touch triggering an event such as a display of another image and hence a transition to another state. The system controller 110 also, in embodiments, manages price updates of displayed menu items, and optionally payment, and the like.

### Touch Sensing Systems

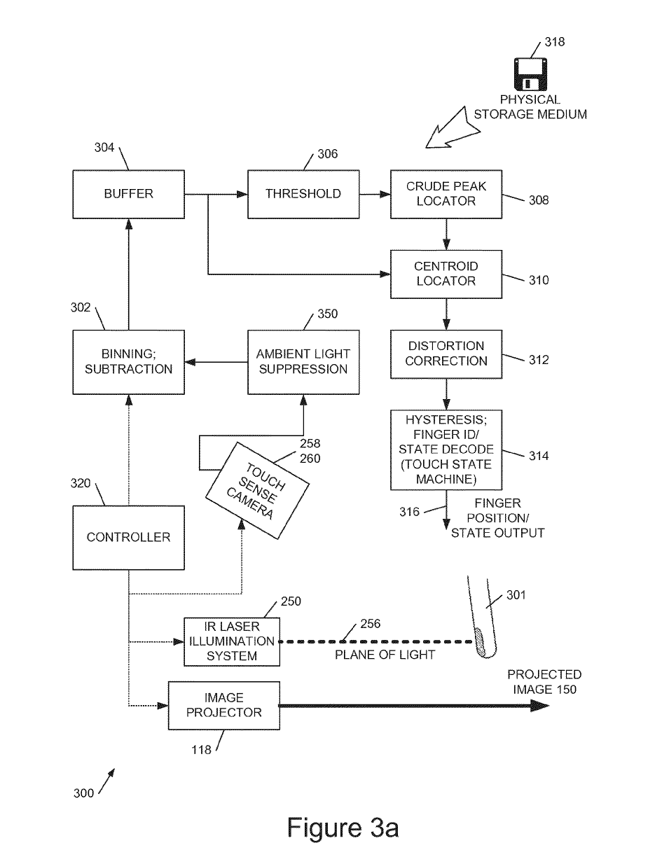

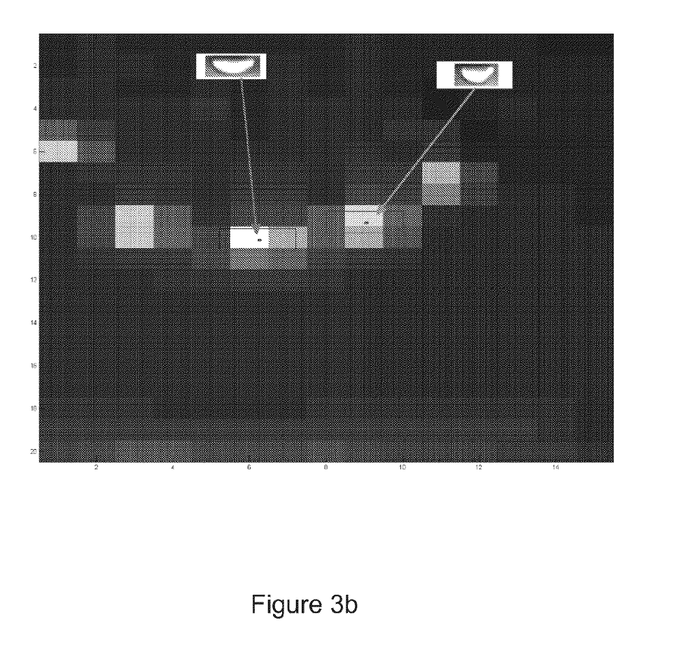

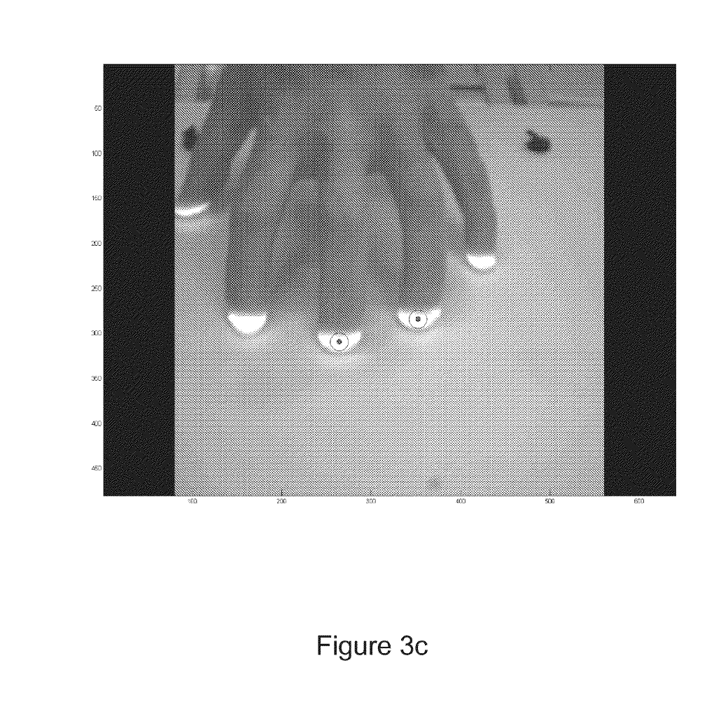

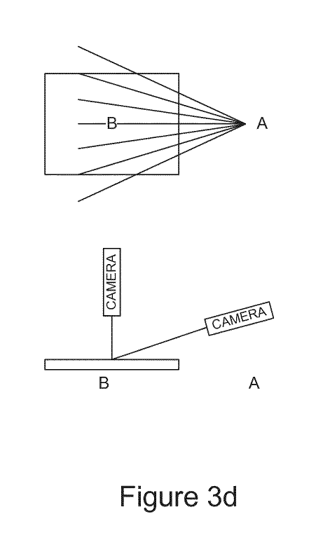

Referring now to FIG. 3a, this shows an embodiment of a touch sensitive image display device 300 according to an aspect of the invention. The system comprises an infra red laser and optics 250 to generate a plane of light 256 viewed by a touch sense camera 258, 260 as previously described, the camera capturing the scattered light from one or more fingers 301 or other objects interacting with the plane of light. The system also includes an image projector 118, for example a holographic image projector, also as previously described.

In the arrangement of FIG. 3a a controller 320 controls the IR laser on and off, controls the acquisition of images by camera 260 and controls projector 118. In the illustrated example images are captured with the IR laser on and off in alternate frames and touch detection is then performed on the difference of these frames to subtract out any ambient infra red. The image capture objects 258 preferably also include a notch filter at the laser wavelength which may be around 780-800 nm. Because of laser diodes process variations and change of wavelength with temperature this notch may be relatively wide, for example of order 20 nm and thus it is desirable to suppress ambient IR. In the embodiment of FIG. 3a subtraction is performed by module 302 which, in embodiments, is implemented in hardware (an FPGA).

In embodiments module 302 also performs binning of the camera pixels, for example down to approximately 80 by 50 pixels. This helps reduce the subsequent processing power/memory requirements and is described in more detail later. However such binning is optional, depending upon the processing power available, and even where processing power/memory is limited there are other options, as described further later.

Following the binning and subtraction the captured image data is loaded into a buffer 304 for subsequent processing to identify the position of a finger or, in a multi-touch system, fingers. Because the camera 260 is directed down towards the plane of light at an angle it can be desirable to provide a greater exposure time for portions of the captured image further from the device than for those nearer the device. This can be achieved, for example, with a rolling shutter device, under control of controller 320 setting appropriate camera registers.

Depending upon the processing of the captured touch sense images and/or the brightness of the laser illumination system, differencing alternate frames may not be necessary (for example, where ‘finger shape’ is detected). However where subtraction takes place the camera should have a gamma of substantial unity so that subtraction is performed with a linear signal.

Various different techniques for locating candidate finger/object touch positions will be described. In the illustrated example, however, an approach is employed which detects intensity peaks in the image and then employs a centroid finder to locate candidate finger positions. In embodiments this is performed in software. Processor control code and/or data to implement the aforementioned FPGA and/or software modules shown in FIG. 3 may be provided on a disk 318 or another physical storage medium.

Thus in embodiments module 306 performs thresholding on a captured image and, in embodiments, this is also employed for image clipping or cropping to define a touch sensitive region. Optionally some image scaling may also be performed in this module. Then a crude peak locator 308 is applied to the thresholded image to identify, approximately, regions in which a finger/object is potentially present.

FIG. 3b illustrates an example such a coarse (decimated) grid. In the Figure the spots indicate the first estimation of the center-of-mass. We then take a 32×20 (say) grid around each of these. This is preferably used in conjunction with a differential approach to minimize noise, i.e. one frame laser on, next laser off.

A centroid locator 310 (center of mass algorithm) is applied to the original (unthresholded) image in buffer 304 at each located peak, to determine a respective candidate finger/object location. FIG. 3c shows the results of the fine-grid position estimation, the spots indicating the finger locations found.

The system then applies distortion correction 312 to compensate for keystone distortion of the captured touch sense image and also, optionally, any distortion such as barrel distortion, from the lens of imaging optics 258. In one embodiment the optical access of camera 260 is directed downwards at an angle of approximately 70° to the plane of the image and thus the keystone distortion is relatively small, but still significant enough for distortion correction to be desirable.

Because nearer parts of a captured touch sense image may be brighter than further parts, the thresholding may be position sensitive (at a higher level for mirror image parts) alternatively position-sensitive scaling may be applied to the image in buffer 304 and a substantially uniform threshold may be applied.

In one embodiment of the crude peak locator 308 the procedure finds a connected region of the captured image by identifying the brightest block within a region (or a block with greater than a threshold brightness), and then locates the next brightest block, and so forth, preferably up to a distance limit (to avoid accidentally performing a flood fill). Centroid location is then performed on a connected region. In embodiments the pixel brightness/intensity values are not squared before the centroid location, to reduce the sensitivity of this technique to noise, interference and the like (which can cause movement of a detected centroid location by more than once pixel).

A simple center-of-mass calculation is sufficient for the purpose of finding a centroid in a given ROI (region of interest), and R(x,y) may be estimated thus:

$$x = \frac{{\sum }_{{y}_{S} = 0}^{Y - 1} {\sum }_{{x}_{S} = 0}^{X - 1} {x}_{S} {R}^{n} ( {x}_{S} , {y}_{S} )}{{\sum }_{{y}_{S} = 0}^{Y - 1} {\sum }_{{x}_{S} = 0}^{X - 1} {R}^{n} ( {x}_{S} , {y}_{S} )}$$

$$y = \frac{{\sum }_{{y}_{S} = 0}^{Y - 1} {\sum }_{{x}_{S} = 0}^{X - 1} {y}_{S} {R}^{n} ( {x}_{S} , {y}_{S} )}{{\sum }_{{y}_{S} = 0}^{Y - 1} {\sum }_{{x}_{S} = 0}^{X - 1} {R}^{n} ( {x}_{S} , {y}_{S} )}$$

where n is the order of the CoM calculation, and X and Y are the sizes of the ROI.

In embodiments the distortion correction module 312 performs a distortion correction using a polynomial to map between the touch sense camera space and the displayed image space: Say the transformed coordinates from camera space (x,y) into projected space (x′,y′) are related by the bivariate polynomial: x′=xCₓy^{T} X′=xCₓy^{τ} and y′=xC_{y}y^{T}; where Cₓ and C_{y} represent polynomial coefficients in matrix-form, and x and y are the vectorised powers of x and y respectively. Then we may design Cₓ and C_{y} such that we can assign a projected space grid location (i.e. memory location) by evaluation of the polynomial:

b=└x′┘+X└y′┘

Where X is the number of grid locations in the x-direction in projector space, and └.┘ is the floor operator. The polynomial evaluation may be implemented, say, in Chebyshev form for better precision performance; the coefficients may be assigned at calibration. Further background can be found in our published PCT application WO2010/073024.

Once a set of candidate finger positions has been identified, these are passed to a module 314 which tracks finger/object positions and decodes actions, in particular to identity finger up/down or present/absent events. In embodiments this module also provides some position hysteresis, for example implemented using a digital filter, to reduce position jitter. In a single touch system module 314 need only decode a finger up/finger down state, but in a multi-touch system this module also allocates identifiers to the fingers/objects in the captured images and tracks the identified fingers/objects.

In general the field of view of the touch sense camera system is larger than the displayed image. To improve robustness of the touch sensing system touch events outside the displayed image area (which may be determined by calibration) may be rejected (for example, using appropriate entries in a threshold table of threshold module 306 to clip the crude peak locator outside the image area).

### Distortion Correction

We will now describe optical distortion corrected camera optics for light fan touch. Some preferred embodiments of our technique operate in the context of a touch sensitive image display device, the device comprising: an image projector to project a displayed image onto a surface in front of the device; a touch sensor light source to project a plane of light above said displayed image; a camera directed to capture a touch sense image from a region including at least a portion of said plane of light, said touch sense image comprising light scattered from said plane of light by an object approaching said displayed image; and a signal processor coupled to said camera, to process a said touch sense image from said camera to identify a location of said object relative to said displayed image.

As previously described, light fan touch is a technique where a sheet of light is generated just above a surface. When an object, for example a finger, touches the surface light from the light sheet will scatter off the object. A camera will be positioned to capture this light with a suitable image processing system to process the captured image and register a touch event.

The position chosen for the camera is important for system performance in two ways. Referring to FIG. 3d, if we consider an arrangement where a light fan source is positioned at a point A just above the surface to be touched but sufficiently off to the side so that the light sheet covers all parts of the desired touch area, and the touching object is in the center of the touch area at point B. For simplicity consider potential camera positions anywhere in an arc from point A to a point directly above point B. First the camera needs to be sufficiently far from the touch surface so that the whole surface is in the camera field of view. The closer the camera is to A the more back-scattered light can be received, however there is also increased distortion of the touch area (i.e. a rectangular area will no longer appear rectangular). The closer to point above B the camera is, the less distortion but also the less signal is picked up from the back-scatter. Positions away from the arc between A and a point above B as described offer no fundamental advantage in terms of field of view distortion and receive, on average, less scattered light, hence are not considered to provide any benefit.

In existing implementations the camera is typically closer to A than B. In this case the distortion is then corrected in the image processing software. However the distortion then has a critical knock-on effect on the accuracy of the touch system. Consider two points on the touch surface, C and D. C is close to the camera and light fan. D is at the furthest point from the camera on the touch area. Two points 1 cm apart at C will appear much further apart on the camera sensor than the two similarly spaced points at D, often by more than a factor of 2 or even more than a factor of 4 on some systems. At each point there will be an uncertainty in the position of a registered touch. Distortion correction in the software will then magnify the uncertainty for touch events at D. This results in a magnification both of any systematic position measurement errors in the system, and of random noise, which is typically highly undesirable. More generally ineffective use is made of the camera image sensor as the distorted field of view can occupy as little as a third or a quarter of the sensor area, so that the system has a higher data bandwidth requirement than is strictly speaking required in order to achieve a given level of performance.

The ideal case would be where the image of the touch area fills the field of view of the camera with as low a distortion as possible, thus maximizing the information available to the touch detection software, and attempting to ensure that the available information is uniformly distributed over the touch area. We describe an optical system to achieve this.

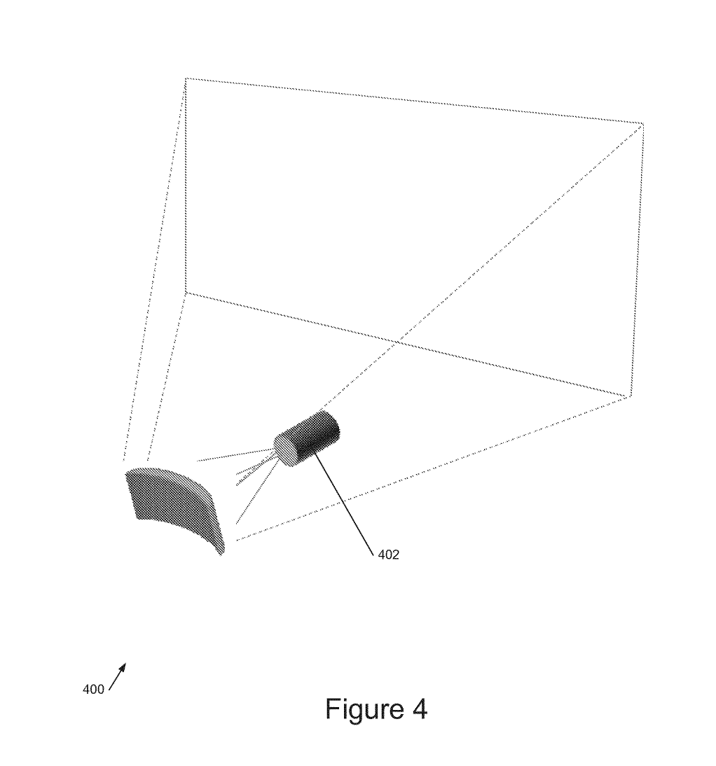

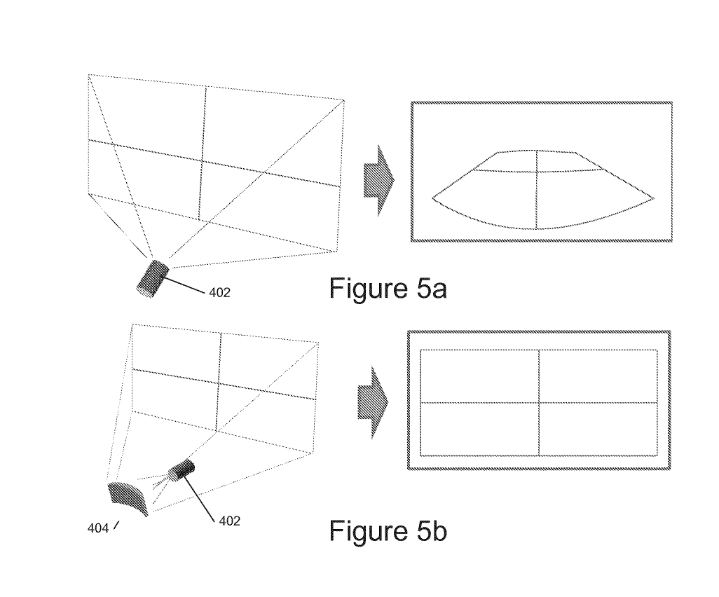

In our technique a minor is used as an intermediary optic between the camera and the touch area. An example of the image capture system 400 is shown in FIG. 4, here comprising a camera 402 and image capture optics including a convex mirror 404. A portion of the light scattered off an object in the touch area will propagate towards the mirror. The mirror is designed such that different areas of the minor reflect light from specific areas of the touch area towards the camera. For example light from the top right of the touch area above will only be reflected towards the camera from the top right portion of the mirror. The shape of the mirror can then be optimized so that a uniform grid of positions on the image sensor receive light only from a similarly uniform grid of positions in the touch area. FIG. 5 shows the typical view seen by a camera with standard wide-angle optics compared to what can be achieved by using optics designed around an optimized reflector. While the distortion can be corrected using suitable software, positional accuracy is considerably reduced in the areas of the image where the camera's view of the touch area is compressed, with the top left and right areas being the worst case examples. Thus use of a suitable minor allows efficient capture of back-scattered light from objects crossing the light sheet without the loss of positional accuracy caused by optical distortion of the camera's view of the touch surface.

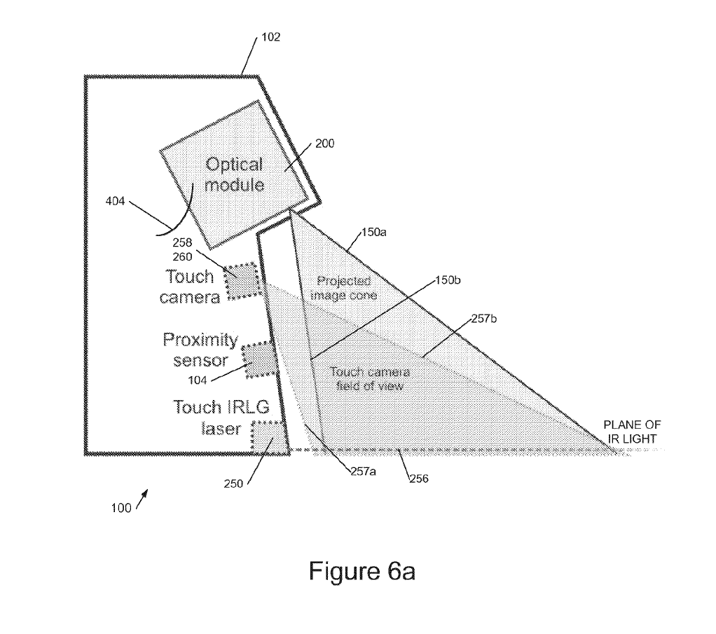

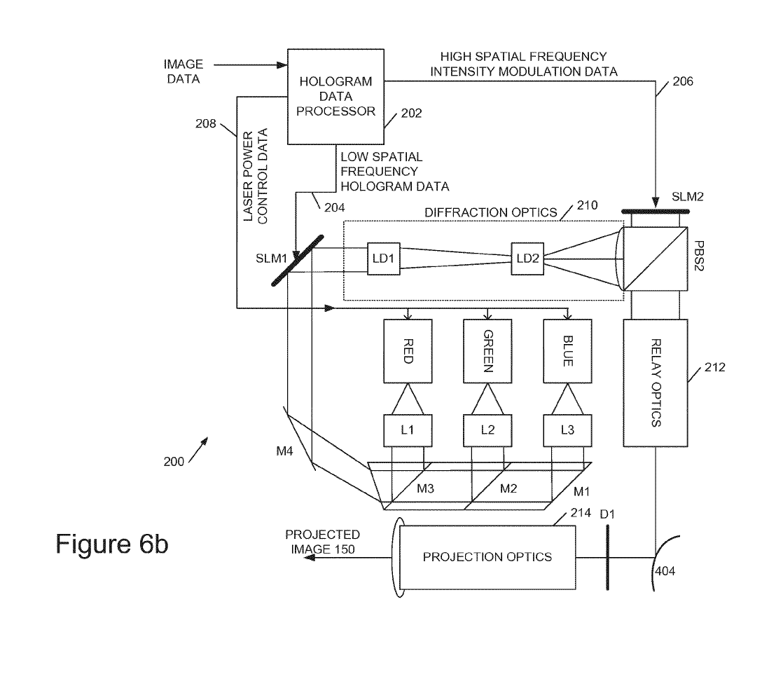

Referring to FIG. 6, a preferred embodiment of this technique uses a reflector common to both the projection and camera optics to distortion correct for both the camera and projector. This may mean that the two are combined along a common optical path, or may mean that different, or overlapping, areas of a minor are used. A key design feature to note is that, while the requirement for projection is that the projected image is sharply in focus on the surface, this requirement is not absolutely necessary for the camera system. So long as any defocus or other blurring effect of the mirror design is known and repeatable this can be accounted for in the image processing of the captured sensor images. Therefore any design compromises required in order to accommodate both devices using a common minor can be biased heavily in favour of the projection system, where high optical fidelity is essential, and hence the use of a common minor should not compromise the projector performance.

It will be appreciated that for the touch sensing system to work a user need not actually touch the displayed image. The plane or fan of light is preferably invisible, for example in the infrared, but this is not essential—ultraviolet or visible light may alternatively be used. Although in general the plane or fan of light will be adjacent to displayed image, this is also not essential and, in principle, the projected image could be at some distance beyond the touch sensing surface. The skilled person will appreciate that whilst a relatively thin, flat plane of light is desirable this is not essential and some tilting and/or divergence or spreading of the beam may be acceptable with some loss of precision.

No doubt many other effective alternatives will occur to the skilled person. It will be understood that the invention is not limited to the described embodiments and encompasses modifications apparent to those skilled in the art lying within the spirit and scope of the claims appended hereto.

1. A touch sensing system, the system comprising:
a touch sensor light source to project a plane of light above a surface;
a camera having image capture optics configured to capture a touch sense image from a region including at least a portion of said plane of light, said touch sense image comprising light scattered from said plane of light by an object approaching said displayed image; and
a signal processor coupled to said camera, to process a said touch sense image from said camera to identify a location of said object;
wherein said image capture optics are configured to capture said touch sense image from an acute angle relative to said plane of light; and
wherein said image capture optics are configured to compensate for distortion resulting from said acute angle image capture.

2. A touch sensing system as claimed in claim 1 wherein said image capture optics are configured to compensate for at least keystone distortion resulting from said acute angle image capture.

3. A touch sensing system as claimed in claim 1 or 2 wherein said image capture optics include a distortion compensating optical element to compensate for distortion resulting from said acute angle image capture.

4. A touch sensing system as claimed in claim 3 wherein said distortion compensating optical element comprises a convex mirror surface.

5. A touch sensing system as claimed in claim 4 wherein said convex mirror surface is an aspheric mirror surface.

6. A touch sensing system as claimed in claim 5 wherein said aspheric mirror surface approximates a shape defined by a conic section.

7. A touch sensing system as claimed in claim 5 or 6 wherein said mirror surface is configured to map bundles of light rays from points on a regular grid in said touch sense image region to a regular grid in a field of view of said camera.

8. A touch sensing system as claimed in any one of claims 2 to 7 wherein said distortion compensating optical element is further configured to provide focussing power to compensate for variation in distances of points within said imaged region from an image plane of said camera due to said acute angle imaging.

9. A touch sensitive image display device including a touch sensing system as claimed in any one of claims 1 to 8, the touch sensitive image display device further comprising an image projector to project a displayed image onto said surface; wherein said touch sensor light source is configured to project said plane of light above said displayed image; and wherein said signal processor is configured to identify a location of said object relative to said displayed image.

10. A touch sensitive image display device as claimed in claim 9 wherein said image projector is configured to project a displayed image onto said surface at a second acute angle, wherein said image capture optics include a distortion compensating optical element to compensate for distortion resulting from said acute angle image capture, and wherein said distortion compensating optical element is shared by said image projector to compensate for said acute angle projection.

11. A touch sensitive image display device as claimed in claim 10 wherein said distortion compensating optical element is configured to provide more accurate distortion compensation for said image projector than for said camera.

12. A touch sensitive image display device as claimed in claim 11 wherein said signal processor coupled to said camera is configured to compensate for residual image distortion arising from said more accurate distortion compensation for said image projector than for said camera.

13. A method of implementing a touch sensing system, the system comprising:
projecting a plane of light above a surface;
capturing a touch sense image from a region including at least a portion of said plane of light using a camera, said touch sense image comprising light scattered from said plane of light by an object approaching said displayed image, wherein said capturing comprises capturing said touch sense image from an acute angle relative to said plane of light;
compensating for distortion resulting from said acute angle image capture using image capture optics coupled to said camera; and
processing a said distortion-compensated touch sense image from said camera to identify a location of said object.

14. A method as claimed in claim 13 further comprising project a displayed image onto said surface at a second acute angle; and using said image capture optics to compensate for distortion from said acute angle image projection.

15. A method as claimed in claim 14 comprising using said image capture optics to more accurately compensate for distortion from said acute angle image projection than from distortion resulting from said acute angle image capture.
